(19) United States
(12) Patent Application Publication
(10) Pub. No.: US 2014/0354441 A1
(43) Pub. Date: Dec. 4, 2014

(54) SYSTEM AND CONSTITUENT MEDIA DEVICE COMPONENTS AND MEDIA DEVICE-BASED ECOSYSTEM

(71) Applicant: Michael Edward Smith Luna, San Jose, CA (US)

(72) Inventor: Michael Edward Smith Luna, San Jose, CA (US)

(21) Appl. No.: 13/906,109

(22) Filed: May 30, 2013

(51) Int. Cl. H04L 12/24

(52) U.S. Cl. CPC H04L 41/0803
USPC 340/686.6

(57) ABSTRACT

Embodiments of the present application relate generally to electrical and electronic hardware, computer software, wired and wireless network communications, wearable, hand held, and portable computing devices for facilitating communication of information and presentation of media. An ecosystem of wireless media devices may be in wireless communication with one another and with at least one wireless user device (e.g., smartphone, tablet or pad). The wireless media devices are configured to detect proximity and/or presence of wireless user devices, objects, or users in proximity of one or more of the wireless media devices and to capture and take over content handling from the at least one wireless user device. In some examples, the wireless media devices are powered by a rechargeable power source, such as a rechargeable battery or the like. Wireless media devices may vary in size such as personal, pocketable, portable, ultra-portable, head worn, shared household, table top, etc.

### CROSS-REFERENCE TO RELATED APPLICATIONS

This application is related to the following applications: U.S. patent application Ser. No. 13/831,422 filed on Mar. 14, 2013 and titled “PROXIMITY-BASED CONTROL OF MEDIA DEVICES” and having Attorney Docket Number ALI-229; U.S. patent application Ser. No. 13/802,646 filed on Mar. 13, 2013 and titled “Proximity-Based Control Of Media Devices For Media Presentations” and having Attorney Docket Number ALI-230; U.S. patent application Ser. No. 13/802,674 filed on Mar. 13, 2013 and titled “Proximity And Interface Controls Of Media Devices For Media Presentations” and having Attorney Docket Number ALI-231; U.S. patent application Ser. No. 13/831,485 filed on Mar. 14, 2013 and titled “MEDIA DEVICE CONFIGURATION AND ECOSYSTEM SETUP” and having Attorney Docket Number ALI-253; U.S. patent application Ser. No. 13/802,528 filed on Mar. 13, 2013 and titled “CLOUD-BASED MEDIA DEVICE CONFIGURATION AND ECOSYSTEM SETUP” and having Attorney Docket Number ALI-241; and U.S. patent application Ser. No. 13/802,689 filed on Mar. 13, 2013 and titled “CHARACTERISTIC-BASED COMMUNICATIONS” and having Attorney Docket Number ALI-194, all of which are hereby incorporated by reference in their entirety for all purposes.

### FIELD

These present application relates generally to the field of personal electronics, portable electronics, media presentation devices, audio systems, and more specifically to new and useful ecosystems of wireless media devices that wireless connect with other wireless devices and expansive data sources to offload content handling from the other wireless devices.

### BACKGROUND

Typical wireless user devices, such as smartphones, tablets, pads, portable gaming systems, and the like often require a user of those devices to manually intervene to change how content presented on those devices is presented to the user. If the user is enjoying content in a first environment (e.g., a movie on a smartphone) and moves to a second environment (e.g., a 5.1 home theater system) where the user has the infrastructure to enjoy the same content, but in a more satisfying way, then the user must typically take manual steps to re-configure the means by which the user may enjoy the content in the second environment. The media that comprises the content the user wishes to enjoy does not follow the user from the first environment to the second environment without some effort on part of the user to transition the playback of the content to suit the second environment. A data payload and a communications bandwidth of the content may also be burdens on the wireless user device. If the content was being wirelessly streamed, for example, then a source of the content is external to the wireless user device and the wireless bandwidth associated with delivering the content may comprise a resource drain on the wireless user device (e.g., the user may have to pay for bandwidth in excess of a monthly maximum). Ideally, devices in the second environment or another environment are configured to recognize the wireless user device, wirelessly link with it, determine which tasks being performed by the device are preferably handled by the devices in the second environment, and transfer some or all of the data and communications payloads over to devices in the second environment such that the content is handled by the devices in the second environment. Moreover, it is desirable for a system of devices to enable content transition from user devices to devices in the system without user intervention and regardless of the brand, manufacture, or operating system of the user devices.

Thus, there is a need for an ecosystem of wireless media devices that recognizes a wide variety of wireless user devices, seamlessly makes wireless links with the wireless user devices, and handles content being served on those wireless user devices.

### BRIEF DESCRIPTION OF THE DRAWINGS

Various embodiments or examples (“examples”) of the present application are disclosed in the following detailed description and the accompanying drawings. The drawings are not necessarily to scale:

FIG. 1 depicts a block diagram of one example of a media device according to an embodiment of the present application;

FIG. 2 depicts an exemplary computer system according to an embodiment of the present application;

FIG. 3 depicts an exemplary ecosystem according to an embodiment of the present application;

FIG. 4 depicts another exemplary ecosystem according to an embodiment of the present application;

FIG. 5 depicts an exemplary block diagram an ecosystem operative as a bridge between wireless user devices and a backend service according to an embodiment of the present application; and

FIG. 6 depicts a block diagram of an ecosystem including a plurality of different wireless media devices according to an embodiment of the present application.

### DETAILED DESCRIPTION

Various embodiments or examples may be implemented in numerous ways, including as a system, a process, an apparatus, a user interface, or a series of program instructions on a non-transitory computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying drawing FIGS. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

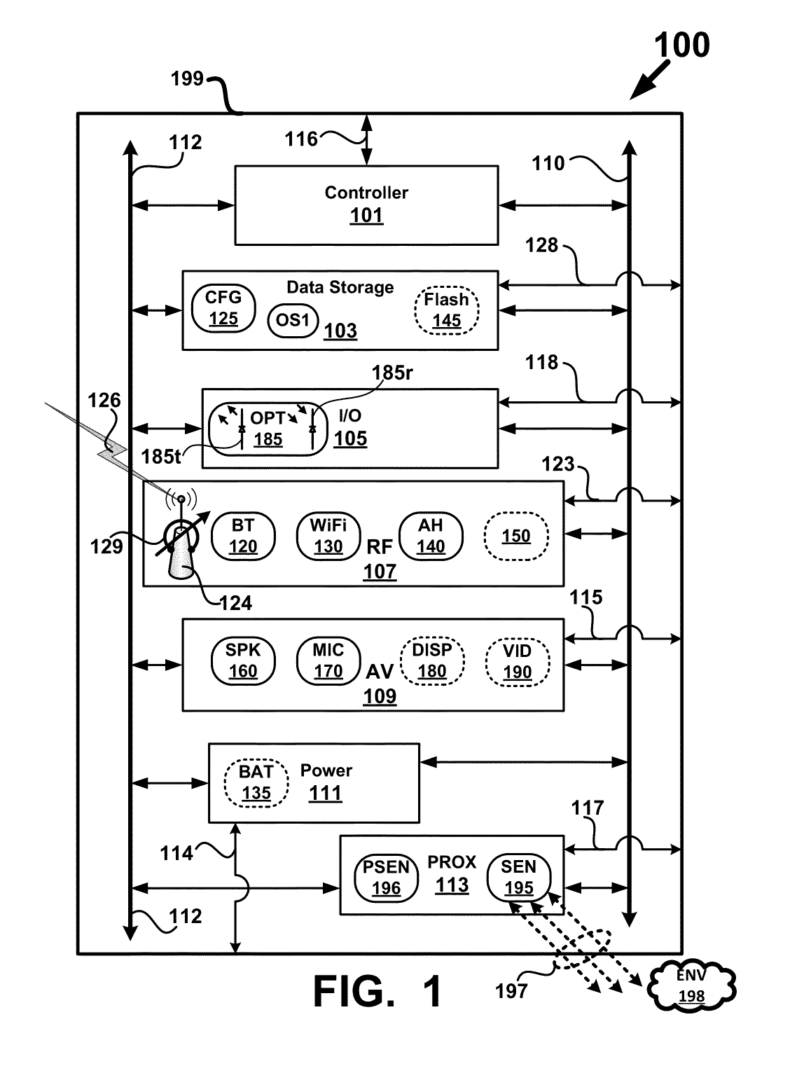

Prior to describing an ecosystem of wireless media devices, attention is directed to FIG. 1, where a block diagram will be used to illustrate one example of architecture for a wireless media device. The architecture depicted is a non-limiting example and the components (e.g., the various blocks depicted in FIG. 1) of the architecture may be the same or different among wireless media devices in an ecosystem. The ecosystem may include just a single wireless media device or a plurality of wireless media devices. The ecosystem may be dynamic and at any given time may vary in the number of wireless media devices present in the ecosystem. Further, dynamics of the ecosystem may include variations in the number of user devices (e.g., wireless user devices) and users that are present in the ecosystem at any given time. Dynamics of the ecosystem may include at any given time the addition of or removal of a selected one or more of media devices, wireless user devices, or users. One or more systems in one or more media devices may be configured to detect (e.g., wirelessly) one or more of presence, motion, or relative position of other media devices, wireless user devices, users, or other objects (e.g., pets) in the ecosystem.

FIG. 1 depicts a block diagram of one embodiment of a wireless media device 100 (media device 100 hereinafter) having systems including but not limited to a controller 101, a data storage (DS) system 103, a input/output (I/O) system 105, a radio frequency (RF) system 107, an audio/video (NV) system 109, a power system 111, and a proximity sensing (PROX) system 113. A bus 110 enables electrical communication between the controller 101, DS system 103, I/O system 105, RF system 107, AV system 109, power system 111, and PROX system 113. Power bus 112 supplies electrical power from power system 111 to the controller 101, DS system 103, I/O system 105, RF system 107, AV system 109, and PROX system 113.

Power system 111 may include a power source internal to the media device 100 such as a battery (e.g., AAA or AA batteries) or a rechargeable battery (e.g., such as a lithium ion or nickel metal hydride type battery, etc.) denoted as BAT 135. Power system 111 may be electrically coupled with a port 114 for connecting an external power source (not shown) such as a power supply that connects with an external AC or DC power source. Examples include but are not limited to a wall wart type of power supply that converts AC power to DC power or AC power to AC power at a different voltage level. In other examples, port 114 may be a connector (e.g., an IEC connector) for a power cord that plugs into an AC outlet or other type of connecter, such as a universal serial bus (USB) connector. Power system 111 provides DC power for the various systems of media device 100. Power system 111 may convert AC or DC power into a form usable by the various systems of media device 100. Power system 111 may provide the same or different voltages to the various systems of media device 100. In applications where a rechargeable battery is used for BAT 135, the external power source may be used to power the power system 111, recharge BAT 135, or both. Further, power system 111 on its own or under control or controller 101 may be configured for power management to reduce power consumption of media device 100, by for example, reducing or disconnecting power from one or more of the systems in media device 100 when those systems are not in use or are placed in a standby or idle mode. Power system 111 may also be configured to monitor power usage of the various systems in media device 100 and to report that usage to other systems in media device 100 and/or to other devices (e.g., including other media devices 100) using one or more of the I/O system 105, RF system 107, and AV system 109, for example. Operation and control of the various functions of power system 111 may be externally controlled by other devices (e.g., including other media devices 100).

Controller 101 controls operation of media device 100 and may include a non-transitory computer readable medium, such as executable program code to enable control and operation of the various systems of media device 100. DS 103 may be used to store executable code used by controller 101 in one or more data storage mediums such as ROM, RAM, SRAM, RAM, SSD, Flash, etc., for example. Controller 101 may include but is not limited to one or more of a microprocessor (μP), a microcontroller (μP), a digital signal processor (DSP), a baseband processor, an application specific integrated circuit (ASIC), just to name a few. Processors used for controller 101 may include a single core or multiple cores (e.g., dual core, quad core, etc.). Port 116 may be used to electrically couple controller 101 to an external device (not shown).

DS system 103 may include but is not limited to non-volatile memory (e.g., Flash memory), SRAM, DRAM, ROM, SSD, just to name a few. In that the media device 100 in some applications is designed to be compact, portable, or to have a small size footprint, memory in DS 103 will typically be solid state memory (e.g., no moving or rotating components); however, in some application a hard disk drive (HDD) or hybrid HDD may be used for all or some of the memory in DS 103. In some examples, DS 103 may be electrically coupled with a port 128 for connecting an external memory source (e.g., USB Flash drive, SD, SDHC, SDXC, microSD, Memory Stick, CF, SSD, etc.). Port 128 may be a USB or mini USB port for a Flash drive or a card slot for a Flash memory card. In some examples as will be explained in greater detail below, DS 103 includes data storage for configuration data, denoted as CFG 125, used by controller 101 to control operation of media device 100 and its various systems. DS 103 may include memory designate for use by other systems in media device 100 (e.g., MAC addresses for WiFi 130, network passwords, data for settings and parameters for NV 109, and other data for operation and/or control of media device 100, etc.). DS 103 may also store data used as an operating system denoted as OS1 for controller 101, or other controllers and/or processors. If controller 101 includes a DSP, then DS 103 may store data, algorithms, program code, an OS, etc. for use by the DSP, for example. In some examples, one or more systems in media device 100 may include their own data storage systems. OS1 may be an operating system that is proprietary to the media device 100.

I/O system 105 may be used to control input and output operations between the various systems of media device 100 via bus 110 and between systems external to media device 100 via port 118. Port 118 may be a connector (e.g., USB, HDMI, Ethernet, fiber optic, Toslink, Firewire, IEEE 1394, or other) or a hard wired (e.g., captive) connection that facilitates coupling I/O system 105 with external systems. In some examples port 118 may include one or more switches, buttons, or the like, used to control functions of the media device 100 such as a power switch, a standby power mode switch, a button for wireless pairing, an audio muting button, an audio volume control, an audio mute button, a button for connecting/disconnecting from a WiFi network, an infrared (IR) transceiver, just to name a few. I/O system 105 may also control indicator lights, audible signals, or the like (not shown) that give status information about the media device 100, such as a light to indicate the media device 100 is powered up, a light to indicate the media device 100 is in wireless communication (e.g., WiFi, Bluetooth®, WiMAX, cellular, etc.), a light to indicate the media device 100 is Bluetooth® paired, in Bluetooth® pairing mode, Bluetooth® communication is enabled, a light to indicate the audio and/or microphone is muted, just to name a few. Audible signals may be generated by the I/O system 105 or via the AV system 107 to indicate status, etc. of the media device 100. Audible signals may be used to announce Bluetooth® status, powering up or down the media device 100, muting the audio or microphone, an incoming phone call, a new message such as a text, email, or SMS, just to name a few. In some examples, I/O system 105 may use optical technology to wirelessly communicate with other media devices 100 or other devices. Examples include but are not limited to infrared (IR) transmitters, receivers, transceivers, an IR LED, and an IR detector, just to name a few. I/O system 105 may include an optical transceiver OPT 185 that includes an optical transmitter 185t (e.g., an IR LED) and an optical receiver 185r (e.g., a photo diode). OPT 185 may include the circuitry necessary to drive the optical transmitter 185t with encoded signals and to receive and decode signals received by the optical receiver 185r. Bus 110 may be used to communicate signals to and from OPT 185. OPT 185 may be used to transmit and receive IR commands consistent with those used by infrared remote controls used to control AV equipment, televisions, computers, and other types of systems and consumer electronics devices. The IR commands may be used to control and configure the media device 100, or the media device 100 may use the IR commands to configure/re-configure and control other media devices or other user devices, for example.

RF system 107 includes at least one RF antenna 124 that is electrically coupled with a plurality of radios (e.g., RF transceivers) including but not limited to a Bluetooth® (BT) transceiver 120, a WiFi transceiver 130 (e.g., for wireless communications over a wireless and/or WiMAX network), and a proprietary Ad Hoc (AH) transceiver 140 pre-configured (e.g., at the factory) to wirelessly communicate with a proprietary Ad Hoc wireless network (AH-WiFi) (not shown). AH 140 and AH-WiFi are configured to allow wireless communications between similarly configured media devices (e.g., an ecosystem comprised of a plurality of similarly configured media devices) as will be explained in greater detail below. RF system 107 may include more or fewer radios than depicted in FIG. 1 and the number and type of radios will be application dependent. Furthermore, radios in RF system 107 need not be transceivers, RF system 107 may include radios that transmit only or receive only, for example. Optionally, RF system 107 may include a radio 150 configured for RF communications using a proprietary format, frequency band, or other existent now or to be implemented in the future. Radio 150 may be used for cellular communications (e.g., 3G, 4G, or other), for example. Antenna 124 may be configured to be a de-tunable antenna such that it may be de-tuned 129 over a wide range of RF frequencies including but not limited to licensed bands, unlicensed bands, WiFi, WiMAX, cellular bands, Bluetooth®, from about 2.0 GHz to about 6.0 GHz range, and broadband, just to name a few. As will be discussed below, PROX system 113 may use the de-tuning 129 capabilities of antenna 124 to sense proximity of the user, other people, the relative locations of other media devices 100, just to name a few. Radio 150 (e.g., a transceiver) or other transceiver in RF 107, may be used in conjunction with the de-tuning capabilities of antenna 124 to sense proximity, to detect and or spatially locate other RF sources such as those from other media devices 100, devices of a user, just to name a few. RF system 107 may include a port 123 configured to connect the RF system 107 with an external component or system, such as an external RF antenna, for example. The transceivers depicted in FIG. 1 are non-limiting examples of the type of transceivers that may be included in RF system 107. RF system 107 may include a first transceiver configured to wirelessly communicate using a first protocol, a second transceiver configured to wirelessly communicate using a second protocol, a third transceiver configured to wirelessly communicate using a third protocol, and so on. One of the transceivers in RF system 107 may be configured for short range RF communications, such as within a range from about 1 meter to about 15 meters, or less, for example. Another one of the transceivers in RF system 107 may be configured for long range RF communications, such any range up to about 50 meters or more, for example. Short range RF may include Bluetooth®; whereas, long range RF may include WiFi, WiMAX, cellular, and Ad Hoc wireless, for example.

AV system 109 includes at least one audio transducer, such as a loud speaker 160, a microphone 170, or both. AV system 109 further includes circuitry such as amplifiers, preamplifiers, or the like as necessary to drive or process signals to/from the audio transducers. Optionally, AV system 109 may include a display (DISP) 180, a video device (VID) 190 (e.g., an image captured device or a web CAM, etc.), or both. DISP 180 may be a display and/or touch screen (e.g., a LCD, OLED, LED, flat panel display, micro or pico-projector) for displaying content, video media, images, information relating to operation of media device 100, content available to or operated on by the media device 100, playlists for media, date and/or time of day, alpha-numeric text and characters, caller ID, file/directory information, a GUI, just to name a few. DISP 180 may comprise more than one display device such as a touch screen for displaying data and a GUI for a user to interact with and a separate image projection device for projecting images, video, content, and the like on a surface, such as a micro-projector or pico-projector, for example. A port 122 may be used to electrically couple AV system 109 with an external device and/or external signals. Port 122 may be a USB, HDMI, Firewire/IEEE-1394, 3.5 mm audio jack, or other. For example, port 122 may be a 3.5 mm audio jack for connecting an external speaker, headphones, earphones, etc. for listening to audio content being processed by media device 100. As another example, port 122 may be a 3.5 mm audio jack for connecting an external microphone or the audio output from an external device. In some examples, SPK 160 may include but is not limited to one or more active or passive audio transducers such as woofers, concentric drivers, tweeters, super tweeters, midrange drivers, sub-woofers, passive radiators, just to name a few. MIC 170 may include one or more microphones and the one or more microphones may have any polar pattern suitable for the intended application including but not limited to omni-directional, directional, bi-directional, uni-directional, bi-polar, uni-polar, any variety of cardioid pattern, and shotgun, for example. MIC 170 may be configured for mono, stereo, or other. MIC 170 may be configured to be responsive (e.g., generate an electrical signal in response to sound) to any frequency range including but not limited to ultrasonic, infrasonic, from about 20 Hz to about 20 kHz, and any range within or outside of human hearing. In some applications, the audio transducer of AV system 109 may serve dual roles as both a speaker and a microphone.

Circuitry in AV system 109 may include but is not limited to a digital-to-analog converter (DAC) and algorithms for decoding and playback of media files such as MP3, FLAG, AIFF, ALAC, WAV, MPEG, QuickTime, AVI, compressed media files, uncompressed media files, and lossless media files, just to name a few, for example. A DAC may be used by AV system 109 to decode wireless data from a user device or from any of the radios in RF system 107. AV system 109 may also include an analog-to-digital converter (ADC) for converting analog signals, from MIC 170 for example, into digital signals for processing by one or more system in media device 100.

Media device 100 may be used for a variety of applications including but not limited to wirelessly communicating with other wireless devices, other media devices 100, wireless networks, and the like for playback of media (e.g., streaming content), such as audio, for example. The actual source for the media need not be located on a user's device (e.g., smart phone, MP3 player, iPod, iPhone, iPad, Android, laptop, PC, etc.). For example, media files to be played back on media device 100 may be located on the Internet, a web site, or in the Cloud, and media device 100 may access (e.g., over a WiFi network via WiFi 130) the files, process data in the files, and initiate playback of the media files. Media device 100 may access or store in its memory a playlist or favorites list and playback content listed in those lists. In some applications, media device 100 will store content (e.g., files) to be played back on the media device 100 or on another media device 100.

In other examples, housing 199 may be configured as speaker, a subwoofer, a conference call speaker, an intercom, a media playback device, just to name a few. If configured as a speaker, then the housing 199 may be configured as a variety of speaker types including but not limited to a left channel speaker, a right channel speaker, a center channel speaker, a left rear channel speaker, a right rear channel speaker, a subwoofer, a left channel surround speaker, a right channel surround speaker, a left channel height speaker, a right channel height speaker, any speaker in a 3.1, 5.1, 7.1, 9.1 or other surround sound format including those having two or more subwoofers or having two or more center channels, for example. In other examples, housing 199 may be configured to include a display (e.g., DISP 180) for viewing video, serving as a touch screen interface for a user, providing an interface for a GUI, for example.

PROX system 113 may include one or more sensors denoted as SEN 195 that are configured to sense 197 an environment 198 external to the housing 199 of media device 100. Using SEN 195 and/or other systems in media device 100 (e.g., antenna 124, SPK 160, MIC 170, etc.), PROX system 113 senses 197 an environment 198 that is external to the media device 100 (e.g., external to housing 199). PROX system 113 may be used to sense one or more of proximity of the user or other persons to the media device 100 or other media devices 100. PROX system 113 may use a variety of sensor technologies for SEN 195 including but not limited to ultrasound, infrared (IR), passive infrared (PIR), optical, acoustic, vibration, light, ambient light sensor (ALS), IR proximity sensors, LED emitters and detectors, RGB LED's, RF, temperature, capacitive, capacitive touch, inductive, just to name a few. PROX system 113 may be configured to sense location of users or other persons, user devices, and other media devices 100, without limitation. Output signals from PROX system 113 may be used to configure media device 100 or other media devices 100, to re-configure and/or re-purpose media device 100 or other media devices 100 (e.g., change a role the media device 100 plays for the user, based on a user profile or configuration data), just to name a few. A plurality of media devices 100 in an eco-system of media devices 100 may collectively use their respective PROX system 113 and/or other systems (e.g., RF 107, de-tunable antenna 124, AV 109, etc.) to accomplish tasks including but not limited to changing configuration, re-configuring one or more media devices, implement user specified configurations and/or profiles, insertion and/or removal of one or more media devices in an eco-system, just to name a few.

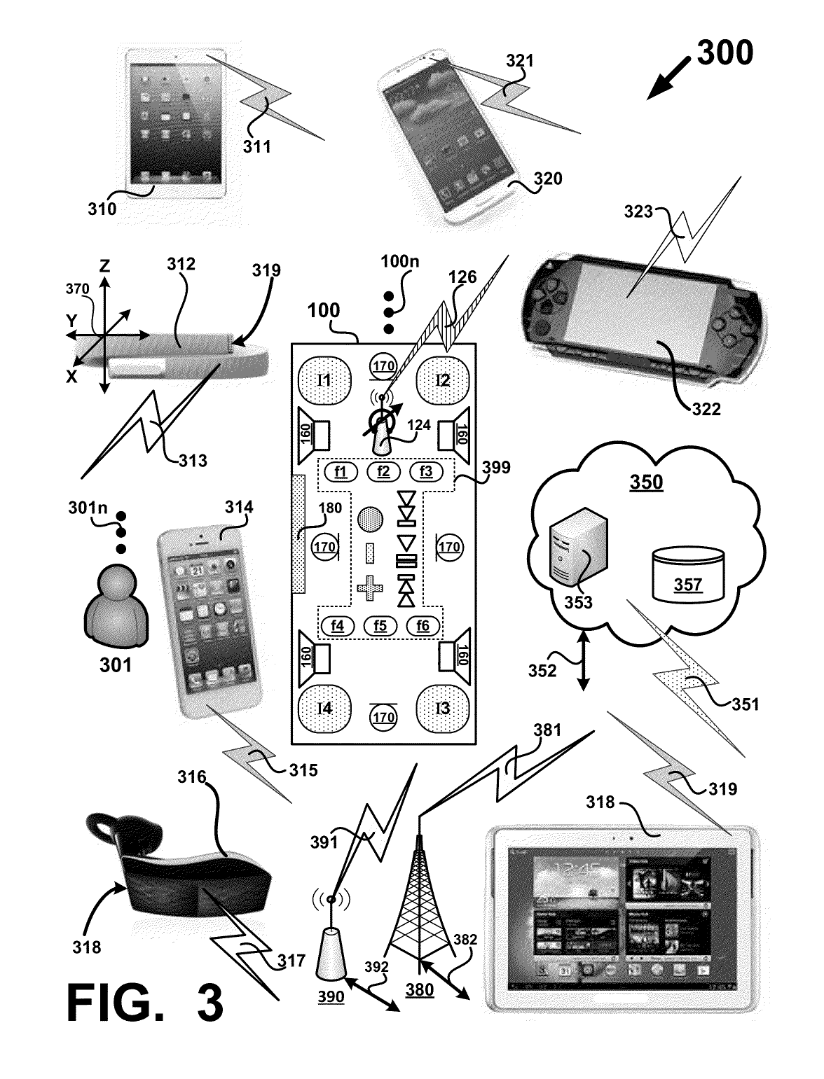

In other examples, PROX 113 may include one or more proximity detection islands PSEN 196 as will be discussed in greater detail in FIGS. 3-6. PSEN 196 may be positioned at one or more locations on chassis 199 and configured to sense an approach of a user or other person towards the media device 100 or to sense motion or gestures of a user or other person by a portion of the body such as a hand for example. PSEN 196 may be used in conjunction with or in place of one or more of SEN 195, OPT 185, SPK 160, MIC 170, RF 107 and/or de-tunable 129 antenna 124 to sense proximity and/or presence in an environment surrounding the media device 100, for example. PSEN 196 may be configured to take or cause an action to occur upon detection of an event (e.g., an approach or gesture by user 201 or other) such as emitting light (e.g., via an LED), generating a sound or announcement (e.g., via SPK 160), causing a vibration (e.g., via SPK 160 or a vibration motor), display information (e.g., via DISP 180), trigger haptic feedback, for example. In some examples, PSEN 196 may be included in I/O 105 instead of PROX 113 or be shared between one or more systems of media device 100. In other examples, components, circuitry, and functionality of PSEN 196 may vary among a plurality of PSEN 196 sensors in media device 100 such that all PSEN 196 are not identical. PSEN 196 may be referred to below as proximity detection islands (I1-I4).

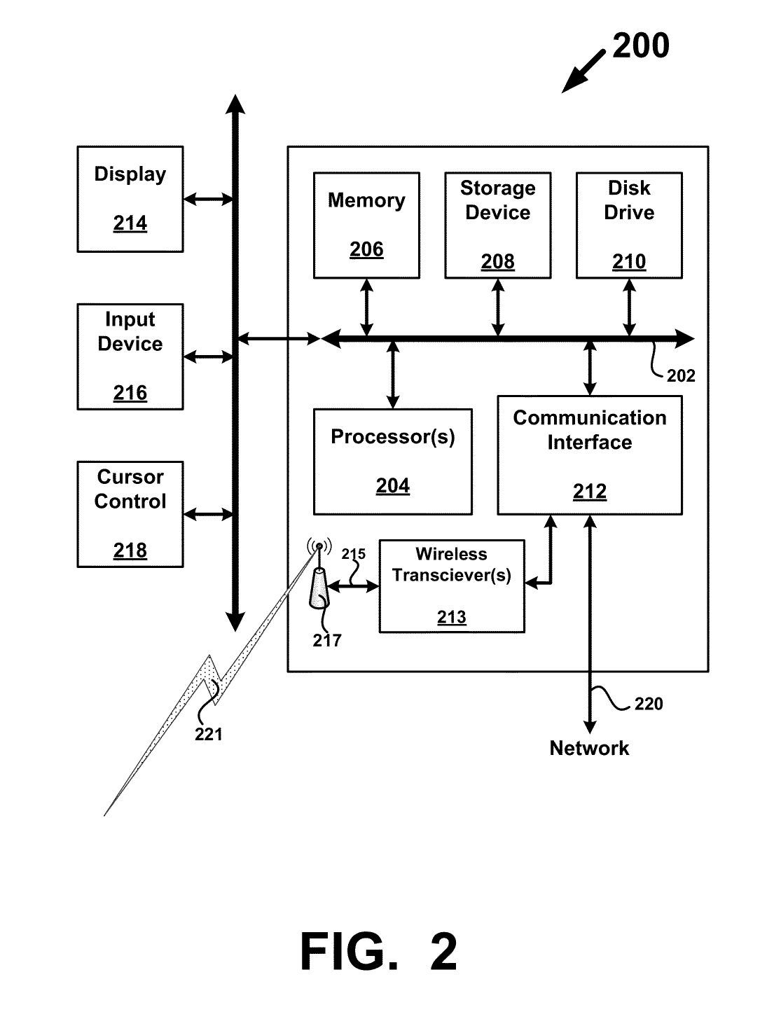

FIG. 2 depicts an exemplary computer system 200 suitable for use in the systems, methods, and apparatus described herein. In some examples, computer system 200 may be used to implement computer programs, applications (e.g., APP's), configurations (e.g., CFG's), methods, processes, or other software to perform the above-described techniques. Computer system 200 includes a bus 202 or other communication mechanism for communicating information, which interconnects subsystems and devices, such as one or more processors 204, system memory 206 (e.g., RAM, SRAM, DRAM, Flash), storage device 208 (e.g., Flash, ROM), disk drive 210 (e.g., magnetic, optical, solid state), communication interface 212 (e.g., modem, Ethernet, WiFi), display 214 (e.g., CRT, LCD, touch screen), input device 216 (e.g., keyboard, stylus), and cursor control 218 (e.g., mouse, trackball, stylus). Some of the elements depicted in computer system 200 may be optional, such as elements 214-218, for example and computer system 200 need not include all of the elements depicted.

According to some examples, computer system 200 performs specific operations by processor 204 executing one or more sequences of one or more instructions stored in system memory 206. Such instructions may be read into system memory 206 from another non-transitory computer readable medium, such as storage device 208 or disk drive 210 (e.g., a HD or SSD). In some examples, circuitry may be used in place of or in combination with software instructions for implementation. The term “non-transitory computer readable medium” refers to any tangible medium that participates in providing instructions to processor 204 for execution. Such a medium may take many forms, including but not limited to, non-volatile media and volatile media. Non-volatile media includes, for example, optical, magnetic, or solid state disks, such as disk drive 210. Volatile media includes dynamic memory, such as system memory 206. Common forms of non-transitory computer readable media includes, for example, floppy disk, flexible disk, hard disk, SSD, magnetic tape, any other magnetic medium, CD-ROM, DVD-ROM, Blu-Ray ROM, USB thumb drive, SD Card, any other optical medium, punch cards, paper tape, any other physical medium with patterns of holes, RAM, PROM, EPROM, FLASH-EPROM, any other memory chip or cartridge, or any other medium from which a computer may read.

Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 202 for transmitting a computer data signal. In some examples, execution of the sequences of instructions may be performed by a single computer system 200. According to some examples, two or more computer systems 200 coupled by communication link 220 (e.g., LAN, Ethernet, PSTN, or wireless network) may perform the sequence of instructions in coordination with one another. Computer system 200 may transmit and receive messages, data, and instructions, including programs, (i.e., application code), through communication link 220 and communication interface 212. Received program code may be executed by processor 204 as it is received, and/or stored in disk drive 210, or other non-volatile storage for later execution. Computer system 200 may optionally include a wireless transceiver 213 in communication with the communication interface 212 and coupled 215 with an antenna 217 for receiving and generating RF signals 221, such as from a WiFi network, BT radio, or other wireless network and/or wireless devices, for example. Examples of wireless devices include but are not limited to: a data capable strap band, wristband, wristwatch, digital watch, or wireless activity monitoring and reporting device; a smartphone; cellular phone; tablet; tablet computer; pad device (e.g., an iPad); touch screen device; touch screen computer; laptop computer; personal computer; server; personal digital assistant (PDA); portable gaming device; a mobile electronic device; and a wireless media device, just to name a few. Computer system 200 in part or whole may be used to implement one or more components of media devices 100 of FIGS. 1 and 3-4. For example, processor 175, wireless module 177, display 110, and optical sensor 120 may be implemented using one or more elements of computer system 200. Computer system 200 in part or whole may be used to implement a remote server or other compute engine in communication with media devices 100 of FIGS. 1 and 3-4.

Turning now to FIG. 3, one example of an ecosystem 300 includes one or more media devices. Here, ecosystem 300 is depicted as including a media device 100 although the ecosystem 300 may include additional media devices as denoted by 100n. Media device 100 may be in wireless communication 126 with other media devices (not shown) and with one or more wireless user devices. Media devices 100 may detect presence and/or proximity of one or more wireless user devices, one or more users 301 or one or more objects. In FIG. 3, ecosystem 300 is depicted as including a plurality of wireless user devices denoted as 310, 312, 314, 316, 318, 320, and 322. However, there may more of fewer wireless user devices than depicted, and in some scenarios, there may be no (zero) wireless user devices. The number and variety of wireless user devices depicted are presented to illustrate the number and diversity of wireless user devices the ecosystem 300 of media device 100 may recognize, wirelessly communicate with, and interact with to serve the needs of one or more users 301. Moreover, the number and variety of wireless user devices depicted also illustrate the ability of the media devices 100 to recognize, wirelessly communicate with, and interact with wireless user devices from a variety of different manufactures. That is, the media devices 100 are configured to seamlessly work with wireless user devices from manufactures other than a manufacture of the media device 100. Ecosystem 300 may also interact with a user 301; however, there may be no users (zero), or there may be more than one user 301 as denoted by 301n. Interaction with a user 301 or other object may include detecting presence and/or proximity of the user 301 or object and one or more of the media devices 100 taking some action or actions based on the detecting.

Wireless user devices 310, 312, 314, 316, 318, 320, and 322 may be in wireless communications with media device 100 using one or more wireless protocols as denoted by 311, 313, 315, 317, 319, 321, and 323. Furthermore, the media device 100 and/or one or more of the wireless user devices may be in wireless communications (351) with one or more of backend services 350. The media device 100 and/or wireless user devices may communicate (381, 391) with backend service 350 via wireless network 380, 390 or both. Although not depicted, communication with backend service 350 may be wired 352 (e.g., LAN, Ethernet, fiber optic), wireless, or both. Wireless networks 380 or 390 may also include a wired connection denoted as 382 and 392 respectively. In some applications there may be no distinction between backend service 350 and the instrumentalities used to access the backend service 350, such as wireless networks 380 or 390. Therefore, in some examples a backend service may include the wired or wireless communications networks that enable communication with the backend service. Backend service 350 may include one or more compute engines such as server 353 and may include one or more data storage devices such as data store 357. Data store 357 may take on many forms such as RAID, HDD, SSD, Flash memory, just to name a few. Server 353 may comprise a server farm or many servers in racks, for example. In other examples, backend service may comprise one or more Cloud based resources or one or more locations/addresses/URL's on the Internet or an intranet.

Media devices 100 may include a variety of features and may have functionalities that differ among the media devices in ecosystem 300. Features and functionalities in the example media device 100 depicted in FIG. 3 may include but are not limited to: one or more speakers SPK 160; one or more microphones MIC 170; one or more proximity detection islands I1-I4 (e.g., PSEN 196); a display 180; a plurality of controls denoted as 399, such as play, pause, fast forward, fast reverse, volume up “+”, volume down “−”, volume mute and/or BT pairing “0”, and one or more function buttons/keys f1-f6; and an RF antenna 124 for use by the various RF transceivers in RF 107.

Some of the wireless user devices may not have the RF communications hardware necessary to access backend service 350 and/or wireless networks 380 and 390. For example, wireless user device 312 may comprise a data capable strap band, wristband, wristwatch, digital watch, or wireless activity monitoring and reporting device. Wireless user device 312 may wirelessly communicate 313 using a Bluetooth protocol with one or more of the media devices 100; however, wireless user device 312 may not be able to directly wirelessly communicate (351, 381, 391) with backend service 350 or wireless networks 380 and/or 390. One of the media devices 100 may establish a wireless communications link with device 312 using its respective BT radio 120 and may, concurrently or subsequently, use another one of its RF transceivers to wirelessly communicate 126 with another resource such as backend service 350 or a wireless network (380, 390). For example, if wireless user device 312 includes data about user 301 (e.g., dietary, calories burned, calorie intake, heart rate, sleep patterns, etc.) that the user 301 wants to upload to the user's page on a social network, the device 312 and media device 100 may negotiate the transfer of that data using the BT link and then the media device 100 may wirelessly link with backend service 350 to transmit/upload the user data to the user's page on the social network. Similarly, data may be pushed from the backend service 350 to the device 312 using the media device 100 as an intermediary communications portal. As one example, data for an alarm to be set on the device 312 may be stored on backend service 350 and transmitted to the media device 100 (e.g., using WiFi 130), which in turns transmits the alarm data to the wireless user device 312 (e.g., using BT 120). Other types of data, such as software or software updates may be downloaded to device 312 from backend service 350 using the media device 100 as a wireless communications link between 312 and 350.

Media devices 100 in ecosystem 300 need not be physically positioned in the same room or location, so long as a communications link (wireless or wired) is maintained between media devices in the ecosystem 300. In the above examples for wireless user device 316, one or more of the media devices 100 may be positioned at different locations or rooms, in a house or office, for example. If user 301 is in room 1 and the audio content is being handled by a media device 100 in room 1, then the user 301 may subsequently move from room 1 to room 2 were another media device 100 is present. The media device 100 in room 1 may handoff the handling of the audio content to the media device 100 in room 2. The handoff may occur once user 301 and/or device 316 are in proximity detection range of the media device 100 in room 2. Alternatively, once the user 301 and/or device 316 move out of proximity detection range of the media device 100 in room 1, that media device may handoff the audio content back to device 316 and the media device 100 in room 2 takes over handling the audio content when the user 301 and/or device 316 are in proximity detection range of the media device 100 in room 2.

User device 316 may be a wireless headset that is configured to wirelessly communicate using BT. Some or all of the media devices 100 in ecosystem 300 may recognize device 316 when it is in RF proximity of the media devices and may arbitrate among the media devices 100 as to which media devices 100 will establish a wireless communications link with device 316 and interact with device 316. As one example, user 301 may be presently in a phone conversation on user device 320 for which the audio portions of the conversation are being handled by headset 316. Sometime after the conversation has commenced the user devices 316 and 320 enter in proximity of one or more of the media devices 100 in ecosystem 300. Media devices 100 may be configured (e.g., via CFG 125) based on user preferences or other criteria, to wirelessly link with device 316 (e.g., using BT) and to transfer the audio content of the conversation to one or more of the media devices 100, such that those media devices 100 serve as a speaker phone or conference call phone. As another example, as the conversation proceeds with the audio being handled by the media devices 100, one or more of the media devices may detect presence and/or proximity of another user/object or user device.

Media devices 100 may be configured (e.g., via CFG 125) based on user preferences or other criteria, to switch the audio content back to device 316 because the user 301 may have set a preference (e.g., via CFG 125) to have private conversations when there are other persons present. Here, any of the various systems of the media devices 100 may have detected presence and/or proximity using one or more of PROX 113, RF 107, or NV 109 to determine that someone other than user 301 is in proximity of the user 301 and may hear his/her conversation. One or more media devices 100 other than the one handling the audio content may be the media device(s) that detects the presence and/or proximity and may wirelessly communicate to the media device 100 that is handling the audio content that presence and/or proximity has been detected, causing the media device 100 that is handling the audio content to switch the audio handling back to wireless user device 316. In some examples, detections of presence and/or proximity may be by the RF signature of another wireless user device that enters within RF detection range of one or more media devices 100 in ecosystem 300. In other examples, one or more proximity detection islands on one or more of the media devices 100 detects presence and/or proximity and wirelessly communicates the detected event to other media devices 100 in the ecosystem 300.

Wireless user devices may be configured to implement control of some functions of a media device 100. For example, user device 316 may transfer handling of a phone call to media device 100 where SPK 160 and MIC 170 allow the media device to function as a speaker phone of conference call phone. If the subject matter of the conversation suddenly requires discretion, user 301 may actuate 318 a button, switch, or other control element on device 316. Upon actuation, device 316 wirelessly signals 317 media device 100 to surrender handling of the conversation back to device 316 where the conversation is now conducted over the headset. If the user 301 actuates 318 the button again, the conversation may be switched back to the media device 100. In other examples, actuation 318 of the button may “Mute” the phone conversation being handled on the media device 100 and a subsequent actuation 318 of the button “Un-mutes” the conversation. CFG 125 on media device 100 and/or an APP 225 installed on user device 316 may be used to orchestrate which device handles content at any given time.

As another example, wireless user device 312 may include one or more accelerometers, gyroscopes, or other sensors that enable the device 312 to sense motion of user 301 when the device is worn or handled by the user 301. Those sensors may sense motion, acceleration, vibrations, rotation, etc., about one or more axes, such as X-Y-Z axes 370. One or more signals generated by those sensors may be processed and may be wirelessly transmitted 313 to media device 100 to effectuate some action on media device 100. For example, user 301 may actuate 319 a button, switch, or other control element on device 312 that wirelessly transmits 313 data (e.g., diametric and activity data collected from user 301) to media device 100 to media device 100. Media device 100 may parse the data and display information regarding the data on display 180 and/or using sound via SPK 160. The data may comprise: 1) calories burned; 2) calories consumed; 3) heart rate; 4) user's weight; 5) miles ran; and 6) sleep activity. Items 1)-6) may be displayed as icons on display 180 and by moving or otherwise articulating his/her wrist or body, the X-Y-Z motions may be converted to signals that are wirelessly transmitted 313 to media device 100 and operative to cause one of the items 1)-6) be highlighted or otherwise selected on display 180. User 301 may actuate 319 the button to cause media device 100 to download the selected item (e.g., user's weight) to a web page the user 301 maintains on backend service 350. More than one of the items 1)-6) may be selected for download.

As another example, display 180 may present information such as the availability of a software update, an alarm, a new set of health/wellness goals, etc. and the user 301 may articulate the device 312 to select one or more items of the displayed information to be uploaded into device 312. Here, even though user device 312 does not have direct wireless access to backend service 350, the Internet, or wireless networks (380, 390), access is nevertheless essentially provided by using the media device 100 as a surrogate or intermediary connection to those wireless resources. If an alarm that has already been set has been handed over to the media device 100 to execute, then upon execution of the alarm (e.g., a wake-up alarm) by media device 100, the user 301 may actuate 319 the button one time to put the alarm in “Snooze” mode or may actuate 319 the button two times to “Cancel” the alarm.

The functionality described above for devices 312 and 316 may apply to the other wireless user devices depicted as examples in FIG. 3, such as devices 311, 320, 322, 314, and 318. A phone call of conference call on devices 320 and/or 314 may be transferred to media device 100 for handling, a VoIP call with audio and/or video content may be presently being handled by devices 311 and/or 318 and may be subsequently transferred over to media device 100. The video portion of the content may remain on display of devices (311, 318) and the audio portion may be transferred over to media device 100 such that the MIC 170 and SPK 160 are used to handle the audio portions of the VoIP call.

Wireless user device 322 may be handling content related to a video game and the audio and/or video content of that game may be transferred to media device 100 for handling. The game may have a surround sound or multi-dimensional (e.g., 3D) sound track. If ecosystem 300 includes a plurality of media devices 100, then those devices may wirelessly 126 communicate with one another and arbitrate which media device 100 will handle which channels of the sound track. For example, if the game includes a 5.1 surround sound track and there are six media devices 100 in ecosystem 300, then a first media device 100 will handle the left channel, a second media device 100 will handle the right channel, a third media device 100 will handle the center channel, a fourth media device 100 will handle the left rear channel, a fifth media device 100 will handle the right rear channel, and a sixth media device 100 will handle the low frequency channel (e.g., subwoofer channel). If there are only three media devices 100 in ecosystem 300, then a first media device 100 will handle the left channel, a second media device 100 will handle the right channel, a third media device 100 will handle the center channel. Those three media devices 100 may act in concert to user their respective A/V systems 109 and processors/controllers to synthesize the left and right rear channels.

Wireless user devices (e.g., 310, 314, 320, 322, 318) that are handling a broad variety of content may, when in proximity (e.g., physical or RF) of ecosystem 300 have that content and optionally the wireless bandwidth associated with the content, transferred over to one or more media devices in ecosystem 300. Furthermore, information or data associated with the content (e.g., playlists, bookmarks, favorites, locations for content, etc.) may be transferred over to one or more media devices in ecosystem 300. The one or more media devices 100 may wirelessly access whatever backend services 350 as necessary to execute handling of the content being transferred. As one example, user 301 may be listening to music from a library of tunes based on a playlist resident on user device 310. The actual data (e.g., content files, MP3, FLAG, AIFF, etc.) are not resident in memory of device 310, but rather are located in a remote external location, such as backend service 350. Upon establishing a wireless communications link with device 310, a media device 100 may wirelessly receive a copy of the playlist from device 310 as well as a location and access information (e.g., username/email address and password) from user device 310 and then wirelessly access backend service 350 or other resource to take over playback of the content on media device 100. Track and timestamp information associated with the current item of content being played back on device 310 may also be transferred so that media device 100 can resume playback at exactly or approximately the same point in time so that there is no or minimal delay or interruption in playback from the standpoint of user 301. Media device 100 may use its own internal data storage system (e.g., DS 103) to store the playlist and/or buffer or store content on the playlist. In some examples, the playlist may reside external to the media device 100 (e.g., on backend service 350). An application (e.g., APP 225) in user device 310 and/or a configuration (e.g., CFG 125) in media device 100 may be used to determine the transfer of content to/from devices 310 and 100. The plurality of controls 399, display 180 (e.g., using a GUI), voice commands received by MIC 170, a display of device 310 (e.g., using a GUI), or other controls on device 310 may be used to control playback of the content being handled by media device 100. For example, a GUI on device 310 may show which track of content is currently being handled by media device 100 and user 301 may touch and icon or the like to cause a variety of functions associated with content playback to occur such as advancing to the next track in the playlist to be played, changing the volume of playback, pausing playback, muting volume, viewing metadata, viewing liner notes, displaying CD/album artwork, just to name a few. Control functions on the media device 100 and user device 310 may be simultaneously active so that user 301 may use either device to control content and/or playback on media device 100.

If more than one wireless user device (e.g., 318 and 310 or 320, 314, and 322) is detected in proximity of the media devices 100 in ecosystem 300, then those media devices 100 may arbitrate which user device is to have its content serviced by which media devices 100. For example, CFG 125 in those media devices 100 may recognize (e.g., via RF signature, MAC address, etc.) that user device 318 is designated as a master device that has preference over other devices that are present in the ecosystem 300. To that end, content from device 318 is serviced by the media devices and other devices that are present in the ecosystem 300 may be placed in a service queue based on the order in which they were detected or in some other queuing order. User 301 may prefer (e.g., via APP 225 and/or CFG 125) that user devices from guests be serviced at a priority that is higher than the user's 301 own wireless devices (e.g., device 314). To that end when device 314 is present and guest device 321 is also present, then media devices 100 will service the content on device 321 and/or allow services provided by the media devices 100 to be accessed by device 321. For example, services provided by media devices 100 may include content and playlists of user 301 that are made available to a user of device 321 to access for playback, etc., or user of device 321 may be granted access to NAS, network printers, or the Internet via a wireless network (e.g., 390) that the media devices 100 use for wireless communication 126 between each other (e.g., WiFi 130) and with external sources (e.g., backend service 350).

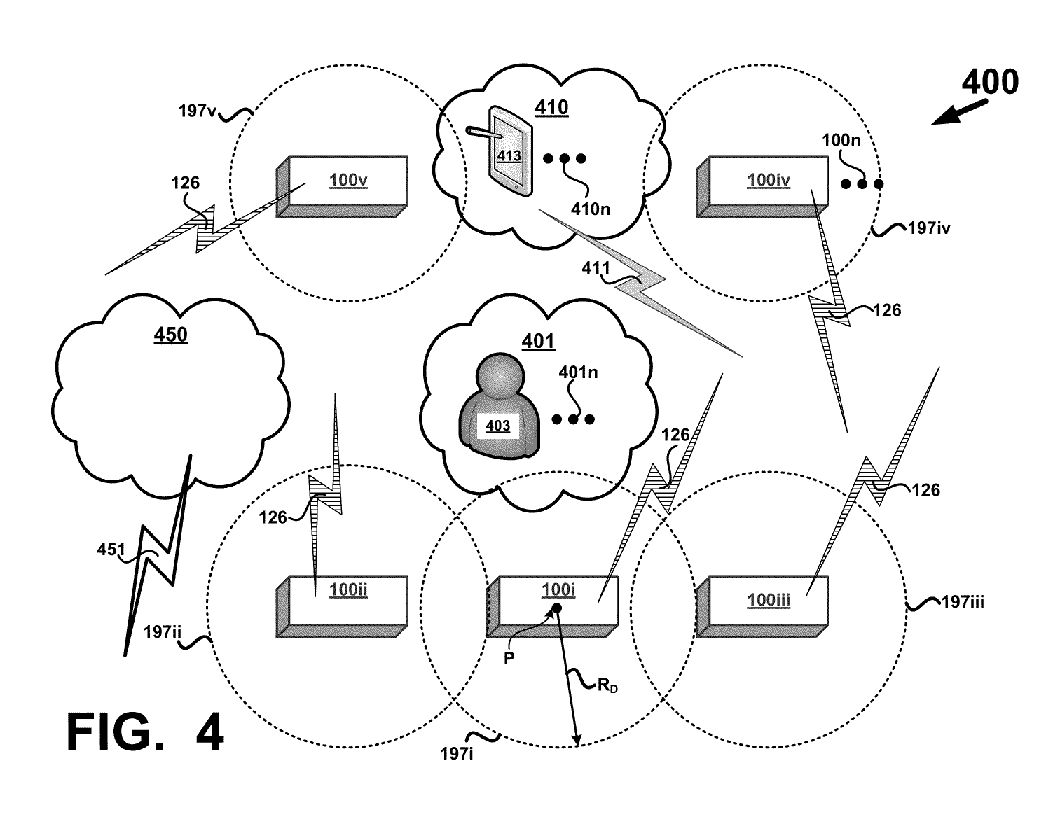

FIG. 4 depicts another example of an ecosystem 400. Ecosystem 400 includes five media devices 100 denoted as 100i-100v; however, ecosystem 400 may include fewer or more media devices than depicted as denoted by 100n. Each media device 100i-100v is in wireless communication (126, 411 and 451) with the other media devices, with user devices 410, and backend service 450. User devices 410 may include at least one user device 413 but may also represent more user devices as denoted by 410n. Backend service 450 may represent one or more resources that may be accessed (wirelessly, wired, or both) directly or indirectly by media devices 100i-100v and optionally user devices 410. Backend service 450 may include but is not limited to data storage systems, compute engines, wireless communications networks, wired communications networks, the Cloud, the Internet, an intranet, NAS, RAID, servers, a data center, a server farm, content sites, a social network, a professional network, content streaming sites, Internet radio, a data base, a web site or web page, Big Data, and the like, just to name a few. Essentially, backend service 450 may represent an entire world of data that is available for access using electronic means such as wireless and/or wired communications networks and their equivalents.

Each media device 100i-100v may include systems for detecting presence and/or proximity as described above. Those systems may collectively create a proximity detection range for each media device 100i-100v denoted as 197i-197v and may generally represent a maximum range at which a media device (100i-100v) may detect presence and/or proximity using its respective systems. Proximity detection ranges 197i-197v may not be the same for each media device and the ranges may overlap for some or all of the media devices 100i-100v in ecosystem 400. For purposes of explanation, proximity detection ranges 197i-197v may be visualized as an approximate radius of detection R_{D} from some reference point P on each media device, where if a user, object, or RF signature is within R_{D}, then that media device will detect presence and/or proximity using its respective systems. The systems for detecting proximity may each have different ranges and approximate radius of detection R_{D} may represent a radius of detection for the system that has the greatest detection range. For example, the RF system 107 may have a greater detection range than the proximity detection system 113 or the A/V system 109. Therefore, a user 403 carrying a wireless user device 413 that is emitting RF signals (e.g., 411) may be detected earlier and at a greater distance from a media device by RF system 107 than detection of the user 403's body by proximity detection islands (I1-I4) in PROX system 113, for example.

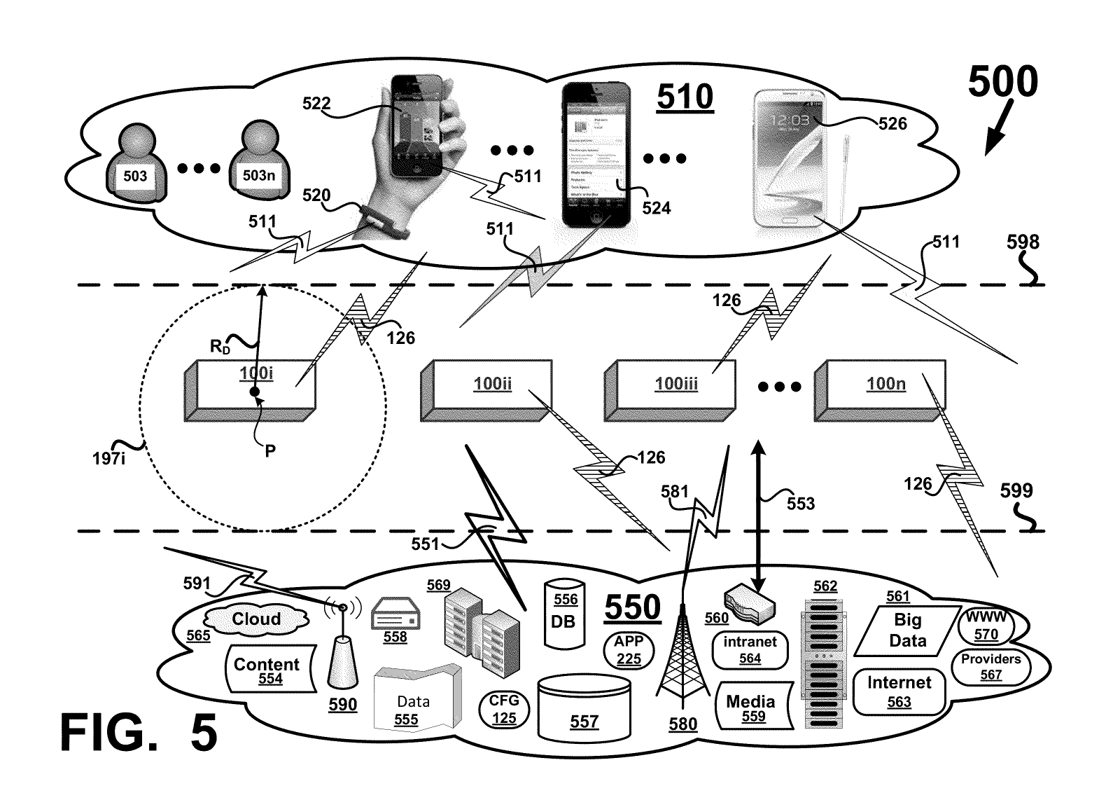

In FIG. 5, a block diagram 500 depicts one example of an ecosystem of wireless media devices operative as bridge between wireless user device and a backend service. Dashed lines 598 and 599 symbolically demarcate different universes of devices that may be part of a system that interacts with an ecosystem of the wireless media devices. Above dashed line 598 there may be a universe 510 of wireless user devices 520-526 and/or users 503-503n who may or may not be associated with one or more of the wireless user device. In some examples, universe 510 may not include any (i.e., zero) users. Universe 510 may include a broad variety of wireless user devices and is not limited to those depicted in FIG. 5 and there may be more or fewer wireless user devices than depicted. In some examples, universe 510 may not include any (i.e., zero) wireless user devices. Some of the wireless user devices may be associated with one another (e.g., via BT pairing, NFC, etc.), for example, data capable band 520 may be associated with smart phone 522 (e.g., via BT pairing or other protocol). Each of the wireless user devices may be in wireless communications 511 with other wirelessly enabled devices in block diagram 500.

Below dashed line 599 a backend service 550 represents a universe of resources available to the universe 510 of wireless user devices 520-526 and/or users 503-503n and to the wireless media devices 100i-100n. Essentially all of the world's data that may be accessed electronically (e.g., wired, wirelessly, or both) may be embodied by backend service 550. Access includes but is not limited to free access, un-restricted access, un-limited access, paid access, restricted access, access by permission, access by account, limited access, and access by login (e.g., user-name/email address and password).

Backend service may electronically communicate with the wireless media devices 100i-100n and/or universe 510 of wireless user devices 520-526 using a variety of means including but not limited to wireless communications 551, 581, and 591, wired communications 553 (e.g., using a router 560 or the like). Wireless resources such as a WiFi router 590 or broadband/cellular 580 may be used by or be components of backend service 550.

Information and/or components of backend service 550 may include but are not limited to: Cloud 565; Internet 563, intranet 564; one or more databases 556; one or more data storage systems 557; RAID 562; NAS 558 (e.g., HDD or SSD); one or more data centers 569; Content 554; Data 555; Big Data 561; WWW 570 (e.g., Web page or Web site, etc.); Providers 567; Media 559; CFG's 125 (e.g., for wireless media devices); APP's 225 (e.g., for wireless user devices); Routers/Switches 560; Wireless networks 590; and Broadband/Cellular networks 580.

Cloud 554 may comprise any information, service, site, storage, data, hardware, software, or instrumentality available for access in Cloud 554. Internet 563 may comprise any location and its associated content that may be accessed on the Internet 563. In some examples, Cloud 565 and Internet 563 may be interchangeable or may overlap in terms of what may be accessed from either one. The intranet 563 may comprise any location and its associated content that may be accessed over an intranet, such as one located behind a firewall or other security screen for the intended purposes of its operator. Content 554 broadly includes any content regardless of form, file type, data type, or structure that may be accessed from backend service 550 for use by wireless media devices and/or wireless user devices. Media 559 broadly includes any media that may be consumed, operated on, displayed, played back, viewed, read, heard, rendered, manipulated, processed, or otherwise of use to wireless media devices and/or wireless user devices. Media 559 and Content 554 may not be mutually exclusive in some examples and the definition of what comprises Media 559 and Content 554 may overlap or be duplicative. Providers 567 broadly includes any service, web site, web page, social or professional network, content provider, streaming media service, Internet radio, Blog, Business, e-Business, retailer, wholesaler, SMS, email, or other entity on the Internet 563 and/or Cloud 565 that may be accessed by wireless media devices and/or wireless user devices. Database DB 556 broadly may be any type or form of database, regardless of content that may be accessed by wireless media devices and/or wireless user devices. Data 555 may broadly be any data that may be accessed by wireless media devices and/or wireless user devices, including but not limited to playlists, shared playlists, family playlists, group playlists, health and/or wellness data, contacts data, calendar data, just to name a few. Big data 561 broadly includes any collection of large data sets that may be accessed and optionally processed or operated on by wireless media devices and/or wireless user devices or compute engine in backend service 550. CFG 125 may include but is not limited to any configuration file used internally by one or more of the wireless media devices as described herein for various purposes including but not limited to communication and control with one or more of the wireless user devices. APP 225 may include but is not limited to any application file used internally by one or more of the wireless user devices for various purposes including but not limited to communication and control with one or more of the wireless media devices.

Referring back to FIG. 5, bridging the universes between users and wireless user devices and backend service 550 are one or more wireless media devices 100i-100n. Users 503-503n, if any, and one or more wireless user devices 520-526, if any, when within proximity (RF or other) range R_{D} of the one or more wireless media devices 100i-100n may access resources available in backend service 550 using systems included in one or more of the media devices 100i-100n. For example, if user 503 of user device 524 is viewing a newspaper article from Media 559 and user 503 and/or user device 524 enter proximity of wireless media device 100iii, then wireless media device 100iii may establish a wireless communications link between 100iii and 524 and the content comprising the newspaper article and any link information (e.g., a URL for the source of the newspaper article and/or login data) may be wirelessly communicated between 100iii and 524 such that handling of the content is now transferred from 524 to 100iii. Wireless media device 100iii, or another wireless media device, may establish a communications link with backend service 550 to access media 559 and the newspaper article may be presented on display 180 of media device 100iii or on some other display connected with media device 100iii or on one of the other media devices. For example, wireless media device 100i may include an HDMI output that is connected with a HD display (e.g., a HDTV or HD monitor) and image data comprising the newspaper article may be wirelessly transmitted 126 from media device 100iii to media device 100i and outputted by media device 100i on its HDMI output for display on the HD display.

Here a data payload and/or wireless bandwidth payload (e.g., 3G or 4G Cellular) associated with handling the content of the newspaper article on wireless user device 524 is offloaded to one of the wireless media devices 100i-100n (e.g., to media device 100iii) and those media devices may use any one of their respective RF transceivers (e.g., WiFi 130) to wirelessly access resources on the backend service 550 (e.g., Media 559). In cases where the content comprises larger data payloads and wireless bandwidth payloads, such as in streaming video, movies or high resolution audio, having the wireless media device(s) offload one or both of those payloads from a user device may be of great advantage to a user. As one example, if user device 522 is viewing an audio/video stream of a feature length movie and is using up some of the allotted monthly data usage for device 522, then when device 522 comes into proximity of media device 100n, media device 100n may wirelessly link with device 522 and take over the data and bandwidth payload from device 522 by using its available wireless resources and wireless connections, such as WiFi or broadband, for example. Further, as media device 100n handles the transferred content, the user device 522 is freed up to perform other tasks for its user, such as phone calls, texting, browsing, etc.

In FIG. 5, the content, data, media, files, playlists, preferences, favorites, photos, videos, images, and other forms of information follow the user devices of a user into and out of the ecosystem of wireless media devices 100i-100n. When a user device transitions (e.g., is carried or moved) from proximity of a media device, whatever services the media device was performing may be transferred back to the user device. After transferring content, control, etc. back to the wireless user device, that device may then make whatever communication links, if any, as necessary to continue handling the content, control, etc. going forward. For example, if a playlist is resident on the user device, then when control of the content is transferred back to the user device the track and time index information for the track being played back on the media device may be wirelessly transmitted to the user device so that the user device may resume playback at the same time index for the same track, thereby making the content transfer as seamless as possible with minimum time delay between the transfer and playback resuming on the user device. As another example, the content may reside on the user device and at the time the media device took control of handling the content, the media device may wirelessly accessed an external version of the content from backend service 550, thereby preventing the user device from having to wirelessly transmit the content to the media device. When the media device hands control of the content back to the user device, the user device may access its resident version of the content and continue playback from that resident version.

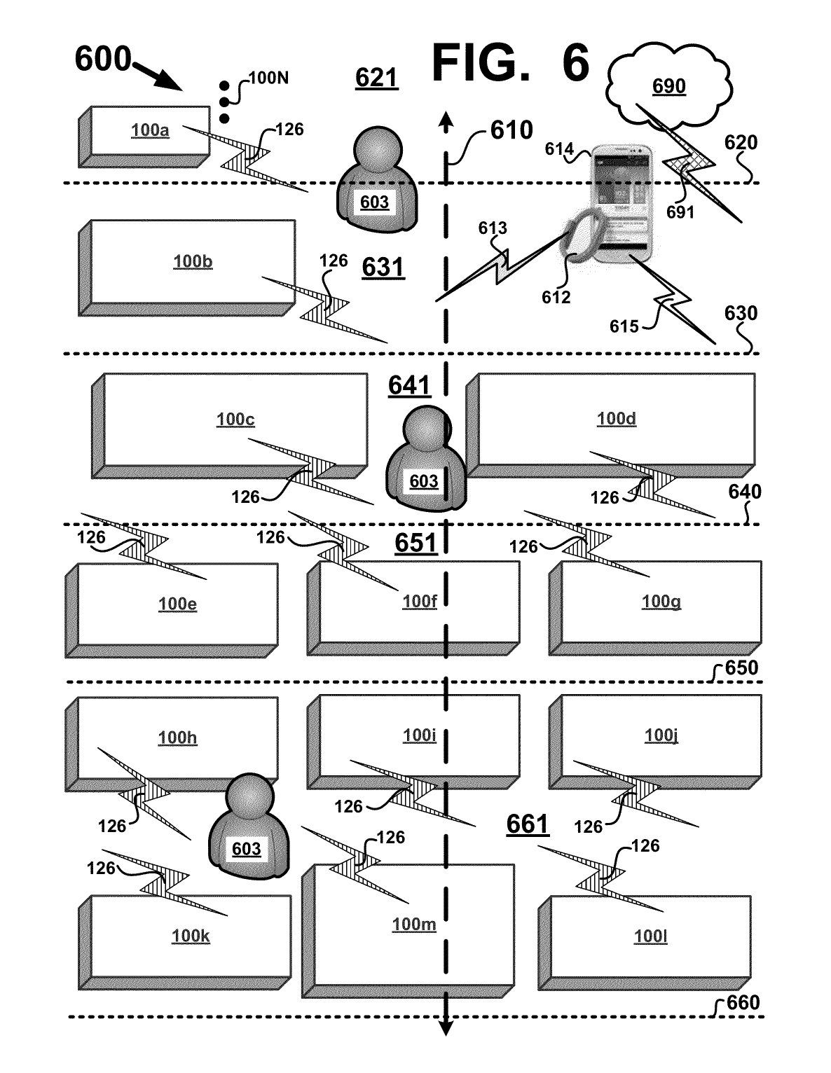

The wireless media devices as described herein may have a variety of different shapes, sizes, capabilities, functionalities, aesthetic elements, form factors, utility, just to name a few. In FIG. 6 an ecosystem 600 includes a plurality of different wireless media devices denoted as 100a-100m. There may be more of fewer wireless media devices than depicted in FIG. 6 as denoted by 100N. The wireless media devices may vary in configuration such that wireless media device 100a is designed to be pocketable, that is, it is sized to be small, transportable, and to fit in typical locations in a user 603's clothing, such as a pocket of a jacket, shirt, sweat top, vest, sweater, back pack, laptop case, shorts, or pair of pants, for example. A pocketable media device 100a may be easily carried in one hand of user 603.

In other examples, media device 100a is designed to be ultra-portable and may be configured to be worn or otherwise connected with a body of user 603, such as a headset, head band, data capable strap band, wristband, wristwatch, digital watch, or wireless activity monitoring and reporting device. Although the ultra-portable size may allow media device 100a to fit in a pocket or the like due to its smaller size, the ultra-portable form factor for 100a is configured to facilitate wearing or otherwise coupling or connecting the media device 100a with user's 603 body. For example, an ultra-portable wireless media device may be configured and may be sized to be head worn (e.g., as an earpiece).

Wireless media device 100b is designed to be portable by user 603 such that it is sized to be easily carried and transported from place-to-place by user 603, but its size is not intended to make it easily fit in a pocket or the like or to be worn by user 603 (e.g., it's not ultra-portable), but 100b may be stowed in an armrest or glove compartment of an automobile, carried in a back pack or purse, set on a surface such as a picnic bench, desk, or table, etc. Therefore, wireless media device 100b is larger than pocketable or ultra-portable wireless media device 100a.

Wireless media devices 100c-100l are designed to a personal size that may vary based on market needs, functionally, features, speaker sizes, enclosure volume need for the speakers, and end use scenarios, for example. Typically, media devices 100c-100l are larger than media device 100b and much larger than media device 100a. Wireless media devices 100c-100l are usually for use in less mobile scenarios such as in a room of a house, business, or some other interior structure. Example locations include but are not limited to an office, place of business, lobby, break room, cafeteria, lunch room, study, library, lounge, conference room, workout room, gym, studio, meeting room, family room, loft, balcony, landing, hotel/motel room, bedroom, bathroom, locker room, patio, deck, home theater, music room, recording studio, terrace, kitchen, breakfast nook, great room, guest room, sound room, just to name a few. Although dimensions and weight may be application dependent, an example range of approximate sizes for media devices 100c-100l include but are not limited to: Length from about 130 mm to about 300 mm; Width from about 30 mm to about 130 mm; and Height from about 40 mm to about 150 mm. An example range of approximate weight includes but is not limited to: from about 0.3 kg to about 4 kg. Some personal wireless media devices may be even larger in size and weigh more than the examples above. As one example, wireless media device 100m may be configured as a subwoofer (e.g., for use in a surround sound or other audio system) and may have an enclosure (e.g., chassis 199) configured to support the low frequency driver size (e.g., SPK 160) and enclosure volume to produce the desired low frequency range of sounds typical of a subwoofer, such as from about 20 Hz to about 100 Hz. Personal sized wireless media devices may be configured to be placed on a surface such as a table, desk, counter, audio rack, speaker stand, pedestal, tripod, bench, or other similar structure. Furthermore, personal sized wireless media devices may be configured to be mounted to a structure such as a wall, beam, pillar, post, ceiling, or the like.

In FIG. 6, the ecosystem 600 may comprise a variety of different wireless media devices that may be positioned in different physical locations. Dashed line 610 represents movement by user 603 and/or one or more user devices 612 and 614 between different zones 621-661 in which different types and numbers of wireless media devices are positioned. Dashed lines 620, 630, 640, 650, and 660 are provided to illustrate a demarcation between the different zones 621-661. Zones 621-661 may represent different rooms or spaces in a structure such as a house, apartment, office, business, dorm, etc. Some of the zones 621-661 may be separated by open spaces, a structure such as a wall or the like, and the zones 621-661 need not be physically adjacent to one another. Wireless media devices 100a-100m may be in wireless communications 126 with one another, with wireless user devices 612 and 614 (e.g., 613 and 615), and with a backend resource 690. A WiFi router or other wireless node may be used to allow the wireless media devices 100a-100m to wirelessly communicate with one another over distances that may vary based on RF capabilities, RF signal strength, structures that may interfere with RF, just to name a few.

Wireless media devices 100a-100m may be in wireless communications 126 with one another using one or more of their respective internal RF systems 107, including AH 140. In some examples, one or more of the wireless media devices 100a-100m may communicate with other of the wireless media devices 100a-100m using an external wireless network (e.g., a WiFi router, WiMAX network, cellular network, or broadband network). For example, media device 110b may wirelessly communicate 126 with media devices 100h-100m using their respective WiFi 130 transceivers with a WiFi network serving as a communications link between the two media devices. As another example, media device 100a may wirelessly communicate with media device 100e by using its BT 140 to communicate with media device 100b and media device 100b uses its AH 140 to communicate with AH 140 of media device 100e such that any information exchange between media devices 100a and 100e are passed through media device 100b as an intermediary or hub.

While in zone 621, user 603 may be accessing content from one or both wireless user devices 614 and/or 612 using media device 100a, which for purposes of explanation will be assumed to be a BT enabled headset worn on an ear of user 603. Further, user 603 is listening to content that comprises music streaming on device 614 using a BT link between device 614 and media device 100a. Lastly, assume that media device 100a only includes a BT transceiver 140 in its RF system. As user 603 moves from zone 621 to zone 631, media device 100b detects one or more of three RF signatures (126, 613, and 615) and/or presence/proximity of user 603. Media device 100b establishes a wireless link with user device 614, determines that 100a is handling content from 614, and takes over the content handling for device 614. Here, media devices 100a and/or 100b may be configured (e.g., via CFG 125) to recognize one each other, determine which device is to dominate content handling in a given scenario, and to take action to switch content handling to the dominate media device. In this example, media device 100b is of larger size and has larger speakers that are able to playback the music being streamed at a higher fidelity and higher volume. User 603 may have pre-set a preference (e.g., via APP 225 on device 614 and/or CFG 125 on media device 100b and/or 100a) that controls which media device in ecosystem 600 is best suited to handling content from the user's wireless devices. Media devices 100b and 100a may or may not establish a BT wireless link between each other to facilitate switching content handling from media device 100a to media device 100b. Zone 621 may have been a car the user 603 was in prior to moving 610 to zone 631 in a room of the user 603's house, for example. Furthermore, while in zone 631, audio content on phone calls on user device 614 will be handled by media device 100b, and optionally by media device 100a if the user 603 take some action (e.g., pushes a button or presses an icon) to make the conversation private.

As another example, user 603 leaves device 614 on a table in zone 631 and moves 610 to zone 641, which is in another room in user 603's house. The music content is still being handled by media device 100b; however, media device 100b no longer detects presence/proximity of user 603 in zone 631, but media devices 100c and 100d detect presence/proximity of user 603 in zone 641. Media device 100c and/or 100d wirelessly communicate with media device 100a and negotiate transferring content handling from media device 100b to media devices 100c and 100d. Here, ecosystem 600 provides two larger media devices 100c and 100d to playback the music content. User 603 may have pre-set a preference to hear playback in stereo (e.g., using two media devices instead of one) or with a larger sound field that may be produced with two media devices that have larger speakers. User 603's media followed the user 603 even though the user's wireless device 614 remained in zone 631. In an alternate example, the user 603 moves from zone 631 to zone 641 with the user device 614 in tow. The result may be the same, with media devices 100c and/or 100d detecting presence/proximity of user 603 and/or device 614 and transferring content handling from media device 100b.

In another example scenario, wireless user device 614 is playing back a multi-channel audio track. Initially, user 603 is in zone 631 and media device 100b wirelessly communicates with device 614 to transfer content handling to media device 100b as described above. Subsequently, user 603 moves 610 from: zone 631 to zone 641; zone 641 to zone 651; and zone 651 to zone 661. As the user 603 moves 610 between zones, media devices in those zones detect the user device 614, the user 603, or both while in their respective zones and take over content handling. While in zone 641, both media devices 100c and 100d playback the multi-channel content using their respective A/V systems 109 to provide at least stereo playback (e.g., left channel and right channel) or synthesized multi-channel playback (e.g., using algorithms and/or processors to synthesize more than two audio channels). For example, a center channel may be synthesized from the multi-channel content. While in zone 651 all three media devices 100e-100g provide at least three channels (e.g., left, right, and center channel) or synthesized multi-channel playback (e.g., left rear and right rear channels are synthesized). While in zone 661 all five media devices 100h-100l provide at least six channels of playback (e.g., 5.1 surround sound) and may synthesize additional channels (e.g., left height and right height channels). Therefore, as the user 603 and/or user devices (614, 612) move between various areas of ecosystem 600 (e.g., zones 621-661) the user's media content follows the user 603 and/or the user's wireless user devices.

In the above scenario, the user device 614 may remain stationary in one of the zones 621-661 and movement of the user 603 between the zones causes the content to follow the user 603 (e.g., from zone 641 to zone 661) as the user 603 is detected by the media devices in a particular zone. The user experience of the content may be upgraded or enhanced in some zones based on the capabilities of media devices in those zones. For example, the user 603 experiences 3 channel playback in zone 651 and that experience is upgraded or improved to a 5.1 experience in zone 661 due to two additional media devices 100k and 100l and subwoofer media device 100m. In the above scenario the user's movement between the zones need not be in the order depicted and the zones may be traversed by the user 603 in a different order. The zones depicted are not necessarily arranged as shown and the user 603 may move from one zone to any zone without passing through other zones, such as moving from zone 621 directly to zone 661 without passing through zones 631, 641, and 651, for example.

Content, data, or other information for user devices 612 and 614 and media devices 100a-100l may be resident in those devices, may be distributed among a plurality of those devices and may reside in whole or in part in backend service 690 as was described above in reference to FIG. 5. In some examples, duplicate copies of content, data, or other information may reside in one or more of backend service 690, media devices 100a-100l, or user devices 612 and 614. Content being handled by one or more media devices need not be resident (e.g., in DS 103) in the media device(s) handling the content. In some examples, a full or partial copy of content, data, or other information may be copied to one or more media devices assigned to handle the content. For example, a wireless user device upon negotiating with one or more media devices that will take over handling of content from the wireless user device may transfer a full or partial copy of the content, data, or other information to one or more of the media devices. The content, data, or other information transferred may include a playlist, the content (e.g., MP3 files), or both. A display (e.g., touch screen), controls, or other instrumentalities on the media devices and/or wireless user device may be used to control content handling, playback, and other functions of media devices that are currently handling content.

Wireless user device 612 may include a RF system that only allows wireless communication using a single protocol, such as BT for example. One or more of media devices 100a-100l may wirelessly link with device 612 upon detecting it and uses its respective RF system to wirelessly transmit data to/from device 612 or to interface device with backend service 690. As one example, alarms and data in device 612 may be handled by media device 100b while device 612 is in zone 631; however, the handling of those alarms and data may be transferred to other media devices in other zones as the user 603 and/or device 612 moves into and out of those other zones. As another example, as device 612 move from zone 631 to zone 651, one or more of media devise 100e-100g may establish a wireless link with 612 and take over handling of content (e.g., alarms, data, etc.). Data to be downloaded to device 612 from a source such as backend service 690 or other (e.g., NAS) and may be wirelessly transmitted from that source (e.g., using WiFi) to one of the media devices linked to device 612 and then the media device may use the link to wirelessly transmit (e.g., using BT) the data to device 612.

The examples depicted in FIG. 6 are non-limiting and ecosystem 600 may include more or fewer users and/or objects, may include more or fewer wireless user devices and different types of wireless user devices. Content handling and functionality of the wireless media devices 100a-100l in ecosystem 600 may dynamically change and be re-tasked based on changes in the ecosystem. Examples include but are not limited to: media devices being added to or removed from the ecosystem 600; media devices moving into and/or out of the zones such that the number of media devices in a zone goes up or down; adding a new media device (e.g., out-of-the-box) to the ecosystem 600 for the very first time; changes in configuration files (e.g., CFG 125) for one or more of the media devices in ecosystem 600; an increase or decrease in the number of users and/or objects in ecosystem 600; an increase or decrease in the number of wireless user devices in ecosystem 600; introduction of a wireless media device into ecosystem 600 for the very first time; and a change in an application (e.g., APP 225) on one or more wireless user devices that have already been recognized (e.g., in CFG 125) by one or more media devices in ecosystem 600. One or more of the wireless media devices 100a-100l depicted in FIG. 6 may be configured to operate as a satellite of one or more of other wireless media devices. For example, functions to be performed in connection with handling content may be distributed among a plurality of the wireless media devices 100a-100l.

A satellite media device need not be in the same zone as the media device(s) it is acting as a satellite for. For example, media device 100i in zone 661 may handle stereo audio content and may use the A/V systems of media devices 100h and 100j to implement the left and right channels of stereo playback. As another example, media device 100e in zone 651 may handle stereo audio content and may use the A/V systems of media devices 100c and 100d in zone 641 to implement the left and right channels of stereo playback (e.g., user 603 has moved 610 from zone 651 to zone 641 and the music content follows user 603).

The systems, ecosystems, wireless media devices, apparatus and methods of the foregoing examples may be embodied and/or implemented at least in part as a machine configured to receive a non-transitory computer-readable medium storing computer-readable instructions. The instructions may be executed by computer-executable components preferably integrated with the application, server, network, website, web browser, hardware/firmware/software elements of a user computer or electronic device, or any suitable combination thereof. Other systems and methods of the embodiment may be embodied and/or implemented at least in part as a machine configured to receive a non-transitory computer-readable medium storing computer-readable instructions. The instructions are preferably executed by computer-executable components preferably integrated by computer-executable components preferably integrated with apparatuses and networks of the type described above. The non-transitory computer-readable medium may be stored on any suitable computer readable media such as RAMs, ROMs, Flash memory, EEPROMs, optical devices (CD, DVD or Blu-Ray), hard drives (HD), solid state drives (SSD), floppy drives, or any suitable device. The computer-executable component may preferably be a processor but any suitable dedicated hardware device may (alternatively or additionally) execute the instructions.

As a person skilled in the art will recognize from the previous detailed description and from the drawing FIGS. and claims set forth below, modifications and changes may be made to the embodiments of the present application without departing from the scope of this present application as defined in the following claims.

Although the foregoing examples have been described in some detail for purposes of clarity of understanding, the above-described inventive techniques are not limited to the details provided. There are many alternative ways of implementing the above-described techniques or the present application. The disclosed examples are illustrative and not restrictive.

What is claimed is:

1. An ecosystem of media devices, comprising:
a plurality of wireless media devices, each media device including
a radio frequency (RF) system including a plurality of different RF transceivers configured for wireless communication using a plurality of different wireless protocols,
an audio and video (NV) system including a plurality of speakers, a plurality of microphones, and at least one display,
a proximity detection system configured to wirelessly detect presence of wireless devices, moving objects, or both, using a selected one or more of the RF system, the A/V system, or a proximity detection island,
a data storage (DS) system including non-volatile memory,
a processor in electrical communication with the DS system, the proximity detection system, the A/V system, and the RF system, and
configuration data (CFG) embodied in a non-transitory computer readable medium included in the DS system and configured for execution by the processor, the CFG including information on the wireless media device and on other wireless media devices in the plurality of wireless media devices, the CFG operative to control functions including wireless communication, operation, control, content handling, device interaction, and proximity detection.

2. The ecosystem of claim 1, wherein the plurality of different RF transceivers includes a Bluetooth (BT) transceiver.

3. The ecosystem of claim 1, wherein the plurality of different RF transceivers includes a wireless network (WiFi) transceiver.

4. The ecosystem of claim 1, wherein the plurality of different RF transceivers includes a broadband wireless transceiver.

5. The ecosystem of claim 1, wherein the plurality of different RF transceivers includes an Ad Hoc (AH) wireless transceiver configured to wirelessly communicate over a proprietary AH wireless network with other wireless media devices in the plurality of wireless media devices using an AH wireless protocol that is proprietary to the plurality of wireless media devices.

6. The ecosystem of claim 1, wherein one or more of the plurality of different RF transceivers is configured for near field communications (NFC).

7. The ecosystem of claim 1 and further comprising:
a de-tunable antenna included in the RF system and electrically coupled with one or more of the plurality of RF transceivers.

8. The ecosystem of claim 7, wherein the proximity detection system is electrically coupled with a signal generated by electrically de-tuning the de-tunable antenna, the signal used by the proximity detection system to wirelessly detect presence of wireless devices, moving objects, or both.

9. The ecosystem of claim 1, wherein the CFG includes information on one or more wireless devices other than the plurality of wireless media devices, the information including data necessary to establish a wireless communications link with the one or more wireless devices using one or more of the plurality of different RF transceivers

10. The ecosystem of claim 9, wherein the CFG is operative to cause the wireless media device to establish a temporary wireless communications link with the one or more wireless devices using a first one of its plurality of different RF transceivers, and subsequently, establish a persistent wireless communications link with the one or more wireless devices using a second one of its plurality of different RF transceivers.

11. The ecosystem of claim 10, wherein the first one comprises a BT transceiver and the second one comprises a WiFi transceiver.

12. The ecosystem of claim 1, wherein the CFG in each wireless media device is modified when one or more wireless media devices are removed from or added to the ecosystem.

13. The ecosystem of claim 12, wherein wireless media devices that were removed from the ecosystem and are subsequently added back to the ecosystem, are recognized by and automatically wirelessly communicate with wireless media devices that remained in the ecosystem.

14. The ecosystem of claim 12, wherein wireless media devices added for a first time to the ecosystem, are recognized by and automatically wirelessly communicate with wireless media devices already present in the ecosystem.

15. The ecosystem of claim 1, wherein one or more of the plurality of wireless media devices are in wireless communication with a backend service and wirelessly access at least a portion of content to be handled by one or more of the plurality of wireless media devices from the backend service.

16. An ecosystem, comprising:
a plurality of wireless media devices,
each wireless media device including a plurality of different RF transceivers configured for wireless data communications using different wireless protocols, at least one of the plurality of different RF transceivers is configured to wirelessly connect at least one of the plurality of wireless media devices with a backend service,
each wireless media device is in wireless communications with other of the plurality of wireless media devices using at least one its plurality of different RF transceivers,
each wireless media device including a proximity detection system configured to detect presence, proximity, or both of a selected one or more of
one or more wireless user devices,
one or more users, or
one or more objects,
at least one of the plurality of wireless media devices is configured to establish a wireless link with a wireless user device upon detection of the wireless user device by the proximity detection system, and
at least one of the plurality of wireless media devices is configured, after the wireless link is established, to handle content previously being handled by the wireless user device.

17. The ecosystem of claim 16, wherein the plurality of RF transceivers includes an Ad Hoc (AH) wireless transceiver configured to wirelessly communicate over a proprietary AH wireless network with other wireless media devices in the plurality of wireless media devices using an AH wireless protocol that is proprietary to the plurality of wireless media devices.

18. The ecosystem of claim 16, wherein at least a portion of a data payload for the content being handled by at least one of the plurality of wireless media devices is wirelessly obtained from the backend service.

19. The ecosystem of claim 16, wherein each wireless media device further includes an audio and video (A/V) system including a plurality of speakers, a plurality of microphones, at least one display, and an electrically de-tunable antenna.

20. The ecosystem of claim 16, wherein each of the plurality of wireless media devices include substantially identical configuration data (CFG) fixed in a non-transitory computer readable medium,
the CFG configured to execute in a processor included in each wireless media device, and the CFG including data for establishing the wireless link, for connecting with the backend service, and for handling the content.

21. The ecosystem of claim 16, wherein the plurality of wireless media devices are configured to wirelessly access all data from the backend service that is accessible by one or more access types selected from the group consisting of free access, un-restricted access, un-limited access, paid access, restricted access, access by permission, access by account, limited access, access by login, access by user name and password, and access by email address and password.
